(19) United States
(12) Patent Application Publication
(10) Pub. No.: US 2002/0045956 A1
(43) Pub. Date: Apr. 18, 2002

(54) Network distributed motion control system

(76) Inventor: Brian A. Kapitan, Racine, WI (US)

Correspondence Address: Thomas R. FitzGerald, JAECKLE FLEISCHMANN & MUGEL, LLP, 39 State Street, Rochester, NY, 14614-1310, US

(21) Appl. No.: 09/767,241

(22) Filed: Jan. 22, 2001

Related U.S. Application Data
(60) Provisional application No. 60/183,489, filed on Feb. 18, 2000.

(51) Int. Cl. G05B 19/18

(52) U.S. Cl. 700/56; 709/208; 700/2

(57) ABSTRACT

A method of communicating within a motion control system includes programming a plurality of drive cards to perform predetermined mathematical and logical functions in response to high-level commands. Each of the drive cards is configured with a respective unique predetermined delay time. Intelligence is distributed throughout the motion control system by electrically interconnecting each of the drive cards with a local area network and to a corresponding component of the motion control system. High-level commands are transmitted to the drive cards across the local area network. The response by each of the drive cards to the high-level commands is delayed according to the unique predetermined delay time. Each of the drive cards respond to the high-level commands following expiration of the unique predetermined delay time. Communication over the local area network is temporarily suspended following response to the high-level commands by the drive cards to thereby ensure deterministic communication over the local area network.

### CROSS REFERENCE TO RELATED APPLICATIONS

This application claims the benefit of U.S. Provisional Patent Application Serial No. 60/183,489, filed Feb. 18, 2000.

### FIELD OF THE INVENTION

The present invention relates generally to motion control, and, more particularly, to a real-time motion control system.

### DESCRIPTION OF THE RELATED ART

Motion control systems are used in an almost incomprehensibly wide variety of industrial settings and on an equally wide variety of machines in order to automate and expedite material handling, processing and production. Motion control systems vary in complexity from a single controller dedicated to one piece of equipment, to a system utilizing numerous controllers interconnected with and controlling thousands of pieces of equipment or an entire manufacturing plant.

A relatively uncomplicated conventional motion control system typically includes a motion control card. The motion control card is typically a card that plugs into or connects to a PC. Motors, sensors, other components of the motion control system, including various analog and digital interface devices which enable communication between the motion control card and the components of the motion control system, are interconnected to each other and to the motion control card by discrete wires and/or cables. Depending on the space separating the PC-based motion control card from the machine to be controlled, and the number of sensors and motors within the motion control system, a typical motion control system may easily require several miles of wire/cable and have hundreds of connection points. These large amounts of wire and numerous connection points greatly increase the cost and decrease the reliability of a conventional motion control system using a PC-based motion control card.

Furthermore, many motion control card manufacturers utilize custom programming languages and custom software development systems which include enhanced capabilities that enable the creation and debugging of firmware and/or software to be used in the motion control system. These manufacturers also use various other proprietary control technologies, such as, for example, proprietary interfaces. Thus, customization, modification or expansion of a PC-card based motion control system requires the skill and experience of a professional engineer, typically employed by the system manufacturer, having training in, experience with and knowledge of the proprietary technologies, software and development tools.

In an effort to alleviate many of the above-mentioned pitfalls of PC-card based motion control systems, there is a trend toward control systems having open and modular architectures using standardized components. However, many so-called open and modular systems require the purchase and use of proprietary programming software, unique configuration and set-up software, and a proprietary network through which the control system devices communicate. PC-based motion control cards are, in general, purchased with dedicated hardware. Typically, the cards are designed to interconnect with one of the many competing open electrical interface standards, such as, for example, industry standard architecture (ISA), peripheral component interconnect (PCI), or Versa Module Europa (VME). A PC-card designed for use with one of these open interface standards is not interchangeable with a card designed for use with a different interface standard. Thus, configuration and compatibility issues persist despite the existence of so-called open interface standards.

Furthermore, many computer networks are not suited for use in applications, such as motion control, which require real-time data acquisition and predictable communication. The Ethernet is perhaps the most widely used local area network, and has relatively low implementation and maintenance costs. Thus, use of the Ethernet in a real-time motion control system would seem desirable. However, the Ethernet is not suited for use in real-time motion control applications. Communication over an Ethernet network is performed on a contention-based communications protocol. Contention-based protocols give transmission rights to several network nodes or devices at the same time. One or more of the devices having transmission rights may simultaneously place packets of data on the network, thereby resulting in a collision of the data and potentially corrupting data packets. Subsequent to a data collision, contention-based protocols reiteratively grant transmission rights to fewer and fewer devices until a collision-free transmission of data occurs. The Ethernet uses a contention-based protocol known as carrier sense multiple access with collision detection (CSMA/CD). The specification detailing CSMA/CD is found in the International Organization for Standardization, section 8802-3 (ISO-8802-3).

Under a contention-based protocol, a device which is ready to send data across the network waits until the channel is idle and then begins transmitting data. If a collision occurs during transmission, the transmitting device aborts transmission of the data. The transmitting device delays retransmission of the data for a random period of time following the collision. If another collision results from the attempt by the device to retransmit, the device delays the next attempt at transmission by twice the original delay time. Each successive attempt to transmit occurs at a maximum delay of twice the previous period of delay, which is referred to as exponential backoff. Numerous and frequent data collisions are likely to occur on a network having merely a moderate amount of data traffic, and therefore the transmission of data is likely to be frequently and exponentially delayed. Thus, the time period within which a certain data packet will be transmitted in a contention-based network is neither predictable or limited. The late or unpredictable arrival of data in a motion control system creates similarly unpredictable motion or poorly controlled motion. Therefore, an Ethernet network using a contention-based communications protocol is not suitable for use in a real-time motion control system, and has been generally dismissed by industry as a viable motion control network.

A vast majority of PCs currently have as their operating system one of several versions of the WINDOWS operating system (WINDOWS is a trademark of the Microsoft Corporation). WINDOWS has largely replaced its predecessor, the disk operating system (DOS). Thus, a motion control system which is compatible with and runs under the WINDOWS operating systems would seem desirable. However, WINDOWS is not well suited for use in a real-time motion control system. Designing a real time control application that runs under the DOS operating system is a relatively straightforward process. Compared to WINDOWS, DOS is a relatively simple operating system that allows a programmer to take control over virtually all aspects of the operation of a PC, from interrupt requests to direct memory access. Unfortunately, under WINDOWS, this is not the case. Although there are numerous sources of information on how to program within the WINDOWS operating system, it is difficult to find information on the low level architectural aspects which are of importance to the design of a real time control system. Furthermore, WINDOWS is a non-real time operating system. Non-real time operating systems include inherent latencies in the performance of instructions and in communication of data. For example, one version of the WINDOWS operating system, WINDOWS 2000, has a typical latency of approximately 15 milliseconds. The inherent latencies of non-real time operating systems render them virtually incompatible for use in a motion control system.

Therefore, what is needed in the art is a networked motion control system which minimizes the amount of wiring and number of interconnects between components of the system.

Furthermore, what is needed in the art is a networked motion control system which utilizes an open and modular architecture, a well-known and standardized interface, and non-proprietary programming languages.

Even further, what is needed in the art is a networked motion control system which uses a standardized object oriented software interface for the development and testing of software used in configuring and controlling the system to thereby enable interoperability of control systems software.

Still further, what is needed in the art is a networked motion control system that is readily customized, modified and expanded.

Yet further, what is needed in the art is a networked motion control system which enables the Ethernet to operate in a deterministic manner, to thereby overcome the deficiencies inherent in the Ethernet and enable use of the Ethernet as a key component in a networked motion control system.

Moreover, what is needed in the art is a networked motion control system which overcomes the inherent latencies of the WINDOWS operating system to thereby render it suitable for use within a real-time operating system.

### SUMMARY OF THE INVENTION

The present invention provides a method and apparatus for communicating within a motion control system.

The invention comprises, in one form thereof, programming a plurality of drive cards to perform predetermined mathematical and logical functions in response to high-level commands. Each of the drive cards is configured with a respective unique predetermined delay time. Intelligence is distributed throughout the motion control system by electrically interconnecting each of the drive cards with a local area network and to a corresponding component of the motion control system. High-level commands are transmitted to the drive cards across the local area network. The response by each of the drive cards to the high-level commands is delayed according to the unique predetermined delay time. The drive cards respond to the high-level commands following the expiration of the predetermined delay time. Communication over the local area network is temporarily suspended following response to the high-level commands by the drive cards to thereby ensure deterministic communication over the local area network.

An advantage of the present invention is that a motion control system is established using a conventional personal computer running the WINDOWS operating system.

Another advantage of the present invention is that deterministic communication is enabled over an Ethernet network.

Yet another advantage of the present invention is the motion control system operates upon a conventional Ethernet network.

A still further advantage of the present invention is that it eliminates the need for a motion control card.

### BRIEF DESCRIPTION OF THE DRAWINGS

The above-mentioned and other features and advantages of this invention, and the manner of attaining them, will become apparent and be better understood by reference to the following description of one embodiment of the invention in conjunction with the accompanying drawings, wherein:

FIG. 1 is block diagram of the networked motion control system of the present invention;

FIG. 2 is a schematic diagram of a drive card of FIG. 1; and

FIG. 3 is a perspective view of a motor and drive subassembly of the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE DRAWINGS

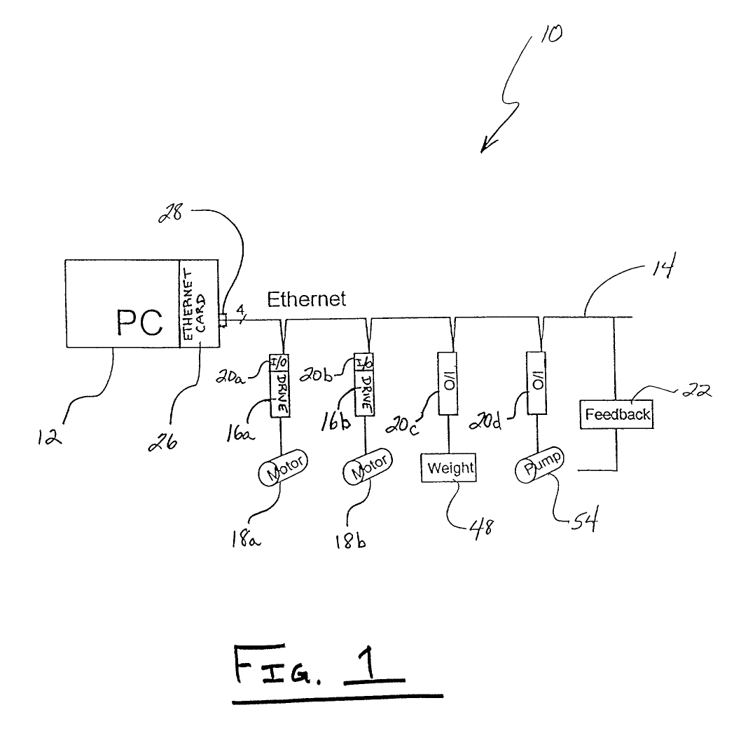

Referring now to the drawings and particularly to FIG. 1, there is shown one embodiment of a networked distributed motion control system of the present invention. Networked distributed motion control system 10 includes personal computer (PC) 12, network 14, drive cards 16a and 16b, motors 18a and 18b, input/output (I/O) devices 20a, 20b, 20c and 20d, and feedback device 22.

PC 12 is a conventional personal computer having a central processing unit, random access and read only memory, hard disk drive, keyboard, mouse and monitor (all of which are not shown). PC 12 further includes a network card 26 and an input/output (I/O) port 28. As will be more particularly described hereinafter, network card 26 and I/O port 28 connect PC 12 to network 14, and enable PC 12 to communicate over network 14 with each of I/O devices 20a-20d, and devices connected thereto. The operation of PC 12 is controlled by a non-real-time operating system, such as, for example, a version of the WINDOWS operating system. Further, PC 12 runs motion control application software which enables PC 12 to arbitrate communication upon network 14, and to transmit, receive and process data to and from I/O devices 20a-20d and device connected thereto.

Network 14 is a conventional Ethernet network which interconnects PC 12 with each of I/O devices 20a and 20b to thereby enable PC 12 to control motors 18a and 18b. PC 12 communicates with weight sensor 48 and pump 54 through I/O devices 20c and 20d. Further, network 14 interconnects each of I/O devices 20a-20d with each other, thereby interconnecting each of motors 18a, 18b, weight sensor 28 and pump 54 to each other. Network 14 provides a single communication channel between the devices connected thereto, such as PC 12 and drive cards 16a-16b. Although not shown, network 14 includes, for example, coaxial cable, fiber optic cable or twisted pair cable, interconnecting one or more hubs and one or more switches. The cable carries data packets throughout network 14. Hubs are connected to numerous network devices, such as I/O devices 20a-20d, on network 14 and cross connect them to each other. Switches are typically multi-port devices which filter and forward the data packets between devices on a network, such as network 14 and drive cards 16a-16d. In the embodiment shown, network 14 is a conventional Ethernet network. However, it is to be understood that network 14 may be alternately configured, such as, for example, an Arcnet network or other similar contention-based network.

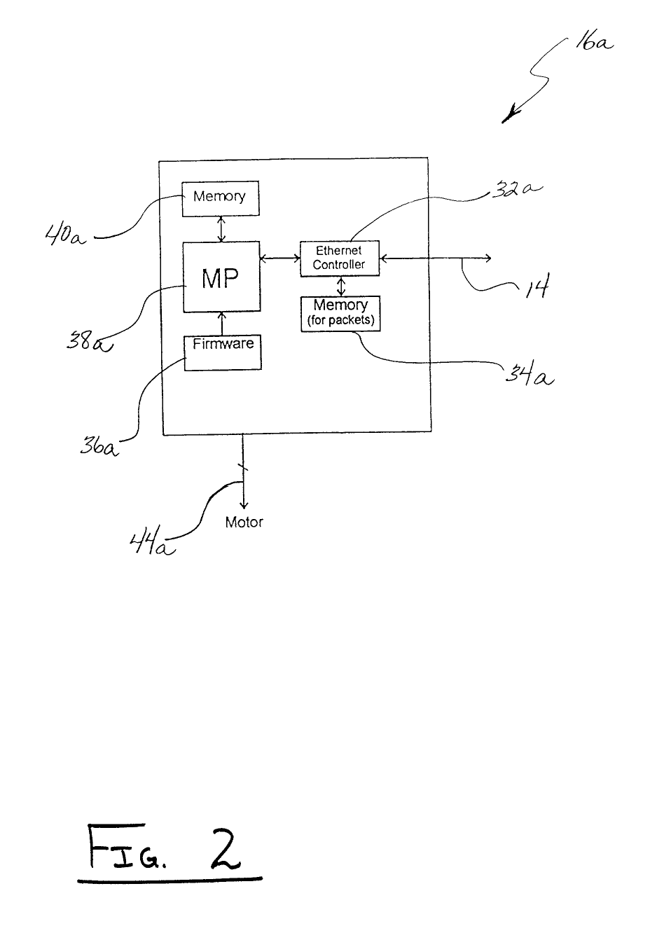

Each of drive cards 16a and 16b are electrically connected to network 14 via I/O devices 20a, 20b, respectively, and to motors 18a, 18b, respectively. Each of drive cards 16a-16b are substantially similar in their structure and function, and therefore only drive card 16a is hereinafter described in detail. Thus, the structure described below for drive card 16a is equally applicable to drive card 16b. As best shown in FIG. 2, drive card 16a includes an network controller 32a, packet memory 34a, firmware 36a, microprocessor 38a and memory 40a. Similarly, drive card 16b includes network controller 32b, packet memory 34b, firmware 36b, microprocessor 38b and memory 40b (none of which are shown).

Network controller 32a is a conventional Ethernet controller, and is electrically connected to network 14, to packet memory 34a, and to microprocessor 38a. Network controller 32a is the interface between drive card 16a and network 14. Network controller 32a performs various functions, such as, for example, placing data upon and receiving data from network 14, monitoring communication and data flowing through network 14, forwarding data to or receiving data from microprocessor 38a, and placing data in or forwarding data from packet memory 34a. In the embodiment shown, network controller 32a is a conventional Ethernet controller. However, it is to be understood that network controller 32a can be alternately configured to so as to be compatible with various configurations of network 14.

Packet memory 34a is electrically connected to network controller 32a, and stores or buffers data to be placed on network 14 and/or transferred to microprocessor 38a via network controller 32a. More particularly, packet memory 34a stores or buffers packets of data received via network 14 from a device connected thereto, such as, for example, PC 12. The received data is buffered by packet memory 34a until microprocessor 38a requests the data for manipulation or other processing, such as, for example, addition, subtraction or logical operations. Further, packet memory 34a is used to store or buffer packets of data received from microprocessor 38a which is to be transferred via network 14 to a device connected thereto, such as, for example, PC 12. Packet memory 34a is configured as a random access memory device, such as, for example, a random access memory integrated circuit or a removable random access memory card, having a predetermined memory size.

Firmware 36a is a read-only computer program stored in, for example, a read-only memory integrated circuit (not shown). Firmware 36a controls the operation of microprocessor 38a. Firmware 36a enables microprocessor 38a to perform a variety of preprogrammed tasks, such as, for example, a cubic-spline interpolation, other mathematical or logical operations, or determining one or more output data packets dependent upon inputs and outputs received via network 14. Thus, drive card 16a is preprogrammed to perform, via firmware 36a and microprocessor 38a, operations of substantial complexity.

Microprocessor 38a is a conventional 16 or 32 bit microprocessor, a reduced instruction set processor (RISC processor) or a digital signal processor (DSP), such as, for example, a Texas Instruments C32 or Siemens 166. Microprocessor 38a receives data directly from network 14, and receives buffered data from packet memory 34a, via network controller 32a. Similarly, microprocessor 38a sends data over network 14 via network controller 32a. Microprocessor 38a sends data to and receives data from a device, such as, for example, a motor or sensor connected to input/output (I/O) lines 44a. The number of I/O lines 44a will vary depending in part upon the amount of data expected to be exchanged between the device and microprocessor 38a. In a typical networked distributed motion control system 10, I/O lines 44a will include from approximately 48 to approximately 112 signal lines. The capacity (i.e., the speed, internal registers, word size, etc.) of microprocessor 38a is selected according to the requirements of the particular application or class of applications for which networked distributed motion control system 10 is to be used.

Memory 40a is electrically connected to microprocessor 38a, and is used by microprocessor 38a to store and retrieve raw, intermediate and processed data. Memory 40a is configured as a random access memory device, such as, for example, a random access memory integrated circuit or removable memory card. The capacity of memory 40a is selected to conform to the requirements of a particular application or class of applications for which networked distributed motion control system 10 is to be used.

Each of motors 18a and 18b are connected to network 14 via drive cards 16a, 16b and I/O devices 20a, 20b, respectively. Each of motors 18a and 18b are substantially similar in their structure, function and method of operation, and therefore only motor 18a is hereinafter described in detail. Thus, the structure, function and method of operation described below for motor 18a is equally applicable to motor 18b. Motor 18a is electrically connected to motor output 44a of drive card 16a. Motor 18a is actuated to undergo controlled motion by the receipt by microprocessor 38a of an appropriate command sent over network 14. The command is sent by PC 12 over network 14 and is received by I/O device 20a. Network controller 32a either forwards the command directly to microprocessor 38a or to packet memory 34a where the command is buffered until it is requested by microprocessor 38a. Microprocessor 38a, in conjunction with firmware 36a, then analyzes and/or translates the command into electrical signals which are then sent via I/O lines 44a to control the actuation of motor 18a. Motor 18a is used, for example, to rotate a turntable, belt, or tool through any necessary and appropriate mechanical linkages (not shown). Motor 18a is configured as, for example, a stepper motor or DC motor.

Input/output (I/O) devices 20a-20d are each electrically connected to network 14 and to an associated component of networked distributed motion control system 10. I/O devices 20a-20d are configured as relatively simple Ethernet I/O cards which facilitate the exchange of data over network 14. I/O devices 20a, 20b each transfer data between network 14 and drives 16a, 16b, respectively. I/O device 20c transfers data between network 14 and weight sensor 48. I/O device 20d transfers data between network 14 and pump 54, and is configured to turn pump 54 on and/or off in response to an appropriate command received via network 14.

It should be particularly noted that each of drive cards 16a-16b are intelligent devices capable of substantially complex mathematical and logical operations in response to commands from PC 12. More particularly, by virtue of their respective microprocessors 38a-b executing the program steps contained within their respective firmware 36a-b, each of drive cards 16a-16b accept and respond to high-level commands, such as, for example, a command from PC 12 to accelerate to ten revolutions/second in one revolution. Such high-level motion commands are encoded by PC 12 and sent over network 14 in relatively small data packets. The high-level commands are translated and/or decoded by drive cards 16a, 16b into low level, detailed commands and, ultimately, to electrical signals which are placed on I/O lines 44a, 44b to actuate motors 18a, 18b, respectively. The transmission by PC 12 of high-level commands in a small number of data packets substantially reduces the number of data packets which networked distributed motion control system 10 must transmit relative to the number of data packets which must be transmitted by a conventional motion control system in order to accomplish the same result.

Microprocessors 38a-b and firmware 36a-b enable each of drive cards 16a-b, respectively, to take the high-level commands and compute, for example, the required trajectory and close position loops around the computed trajectory in real time. In a conventional PC-card based motion control system, high-level commands are first translated, via computation and logical operations, to detailed low-level instructions. It is the detailed low-level instructions which are transmitted across the conventional PC-card based motion control network. In contrast, the translation of high-level commands to detailed low-level instructions is performed within networked distributed motion control system 10 by drive cards 16a and 16b. Any device which requires detailed low-level instructions is connected to network 14 through a respective drive card. Thus, intelligence is distributed throughout networked distributed motion control system 10. Therefore, PC 12 is required to perform very little complex calculation and/or very few complex logical operations in order to transmit data which is sufficient to control a device, such as motor 18a, connected thereto. Rather, PC 12 serves the simpler and less complicated tasks of arbitrating the use of network 14 and of forwarding data from I/O devices 20a-20d to the end-user's motion control application software.

Networked distributed motion control system 10 overcomes the inherent deficiencies in network 14 relative to its use in a real-time motion control system by establishing, via firmware 36a, 36b and application software resident in PC 12, a master-slave relationship between PC 12 and the devices connected to network 14. PC 12 is configured as the master while I/O devices 20a-20d are configured as slaves. The master, PC 12, is solely responsible for initiating communication on network 14. The slaves, I/O devices 20a-20d, are configured via software to initiate communication only during times when the master, PC 12, has completed a transmission and/or is not transmitting data. In a conventional contention-based network, when the master device has completed a transmission all slaves are configured to begin transmitting simultaneously. The simultaneous slave transmissions result in data collisions in network 14 and possibly loss of data. Networked distributed motion control system 10 establishes a deterministic method of communication within contention-based network 14 by advantageously utilizing the occurrence of data collisions.

Networked distributed motion control system 10 utilizes the collisions by providing, each of I/O devices 20a-20d with unique time delays. Each I/O device 20a-20d responds to a communication from the master, PC 12, based upon its respective unique time delay. The communication by I/O devices 20a-20d is ordered, and thus deterministic rather than contentious communication occurs across network 14.

It is also of note that communication between drive cards 16a-b and I/O devices 20a-20d does not place an intensive processing load upon PC 12. Communication between network devices is called peer-to-peer communication. In conventional contention-based networks, peer-to-peer communication is not communicated to or shared with any device other than the intended recipient device, and is therefore referred to as discrete peer-to-peer communication. Thus, in a conventional contention-based network each network device must communicate individually and separately with every other network device. For example, in a conventional contention-based network having three nodes consisting of a PC, node 1 and node 2, communication occurs from the PC to node 1, from node 1 to the PC, the PC to node 2, node 2 to the PC, node 1 to node 2, and node 2 to node 1. In general, a conventional contention-based network having n nodes requires at least n(n-1) transmissions in order for communication to be complete.

In network distributed motion control system 10, the distribution of intelligent devices such as drive cards 16a-b enables the replacement of a discrete peer-to-peer communication scheme with an open peer-to-peer communication scheme, hereinafter referred to as promiscuous peer-to-peer communication. In the promiscuous peer-to-peer communication scheme of networked distributed motion control system 10, data packets transmitted upon network 14 are received and buffered by each intelligent network device. For example, when PC 12 transfers data packets to or communicates with drive card 16a, the data packets are also received and buffered by drive card 16b. Drive card 16a responds to PC 12 by sending one or more data packets to PC 12. The response sent by drive card 16a is received and buffered by drive card 16b. Thus, only two transmissions are required for communication to occur between and among PC12, drive card 16a and drive card 16b.

In general, a networked distributed motion control system in accordance with the present invention and having n nodes requires only 2(n-1) transmissions in order for communication to be complete. Thus, the amount of time required for communication to occur (i.e., the bandwidth) between and among devices within networked distributed motion control system 10 is substantially reduced relative to a conventional contention-based network having the same number of nodes. Furthermore, the addition of nodes consumes bandwidth at a much faster rate in a conventional contention-based network (i.e., bandwidth of a conventional contention based network is given by n(n-1)) than in networked distributed motion control system 10 (i.e., the bandwidth is given by 2(n-1)).

Drive cards 16a-b each receive data packets transmitted under the promiscuous peer-to-peer communication scheme of networked distributed motion control system 10, and store or buffer the received data packets in packet memory 34a, 34b, respectively. Drive cards 34a, 34b then select, through the operation of microprocessor 38a-b and firmware 36a-b, respectively, information which is relevant to their respective operation. Information not relevant to the operation of the particular drive card is cleared or discarded from its packet memory.

The promiscuous peer-to-peer communication occurs among and between each of drive devices 20a-20d. Promiscuous peer-to-peer communication also occurs among and between each of drive cards 16a, 16b and I/O devices 20c, 20d. For example, the outputs of I/O devices 20c, 20d, which are indicative of, for example, data from sensors and relays, are communicated back to PC 12 and/or are used to control the operation of one of drive cards 16a-b. Further, it should be noted that drive cards 16a-b, in contrast to a conventional motion control system drive card, do not require analog-to-digital conversion circuitry in order to process network signals. Drive cards 16a-b, also in contrast to a conventional motion control system drive card, are configured without discrete inputs, such as, enable and/or reset inputs. Further, drive cards 16a, 16b are configured without discrete outputs, such as fault outputs, required. Thus, drive cards 16a-b require far fewer interconnections to each other and to PC 12 than are required in a conventional motion control system, thereby substantially reducing the amount of wire required and reducing the complexity of networked distributed motion control system 10.

WINDOWS, and other non-real time operating systems, have inherent latencies or unpredictability in the performance of instructions and in the transfer of data. Thus, it is likely that latencies will exist in data communications from a PC operating a non-real time operating system. For example, a data packet desirably transmitted during time period T1 may not be transmitted until one of subsequent time periods T2, T3, T4, or later. This latency in the transmission of data renders synchronization and control of a motion control system difficult, at best, and heretofore rendered a non-real time operating systems ill suited for use in a motion control system. Networked distributed motion control system 10 overcomes the inherent deficiency of a non-real time operating system, such as WINDOWS, for use in a motion control system by determining the inherent latency of the operating system and buffering enough data to survive the latency period inherent in the operating system.

More particularly, networked distributed motion control system 10 buffers data to drive cards 16a and 16b. The amount of data which is buffered is dependent at least in part upon the maximum latency period of the operating system. PC 12 is programmed to continuously monitor the level of data contained within each of drive cards 16a-b. To prevent a latency from adversely affecting networked distributed motion control system 10, PC 12 is configured to ensure that each of drive cards 16a-b have stored in their respective data packet memory 34a-b approximately 50 percent of the data packets anticipated to be required within a predetermined duration of time. This duration of time is dependent, at least in part, upon the worst case latency of the operating system. Upper and lower trigger points are established within the application software of PC 12 such that if, for example, packet memory 34a of drive card 16a falls below about twenty percent of the number of data packets anticipated to be required within the predetermined duration of time, PC 12 will devote more time intervals to transmission of data packets to drive card 16a until an appropriate level of data packets are stored within packet memory 34a. Likewise, if packet memory 34a contains, for example, about seventy percent of the number of data packets which are anticipated to be required within a predetermined duration of time, PC 12 devotes fewer, if any, immediately subsequent time intervals to the transmission of data to packet memory 34a. Rather, PC 12 continues to monitor the number of data packets stored within packet memory 34a until that level drops below, for example, fifty percent of the number of data packets anticipated to be required within a predetermined time period, at which time PC 12 returns to providing data packets to drive 16a at a routine rate. The upper and lower trigger points are determined by the end user of networked distributed motion control system 10.

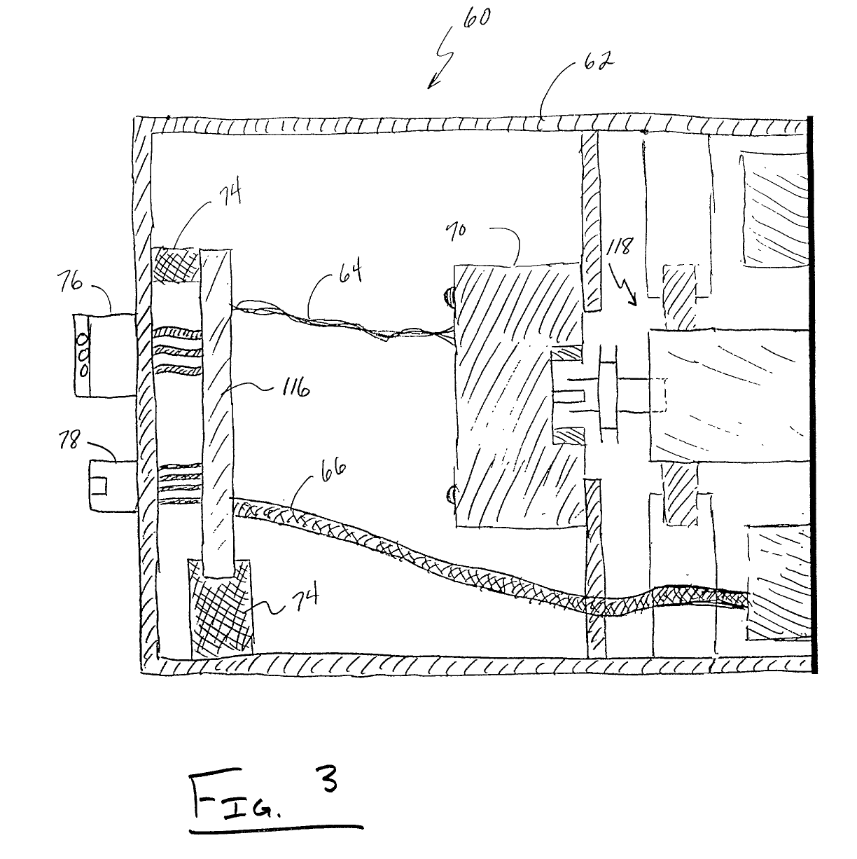

Referring now to FIG. 3, a motor and drive subassembly of the present invention is shown. Motor and drive subassembly 60 includes motor housing 62, within which drive 116, and motor 118 are mounted. Motor housing 62 also includes feedback wires 64, motor stator wires 66, and feedback device 70. Drive 116 is mounted to motor housing 62 by blocks 74, constructed of thermally insulative material, such as, for example, rubber, fiberglass, or other suitable material, to thereby insulate the electronic devices of drive 116 from heat generated by motor 118. Motor housing 62 includes power connector 76 and network connector 78. Drive 116 and motor 118 are substantially similar to drives 16a, 16b and motors 18a, 18b, as shown in FIG. 1 and as described above. Thus, motor and drive card subassembly 60 operably integrates into drive 116 and motor 118. Integration of drive 116 and motor 118 into a single housing provides for the convenient, expedient and efficient mounting of a motor and drive to a piece of equipment which is to be controlled by network distributed motion control system 10.

In the embodiment shown, networked distributed motion control system 10 includes two drive cards 16a-16b, two motors 18a and 18b, and four I/O devices 20a-20d. However, it is to be understood that networked distributed motion control system 10 can be alternately configured to include a greater or fewer number of drive cards, motors, I/O devices, combinations thereof, and other motion control system components.

In the embodiment shown, I/O lines 44a include from approximately 48 to approximately 112 signal lines. However, it is to be understood that I/O lines 44a may be alternately configured with a greater or lesser number of signal lines as dictated by the particular application for which networked distributed motion control system 10 is used.

In the embodiment shown, Drive cards 16a-b are configured without discrete inputs, such as, enable and/or reset inputs. Further, in the embodiment shown, drive cards 16a, 16b are configured without discrete outputs, such as fault outputs. However, it is to be understood that discrete inputs and/or discrete outputs may be incorporated into drive cards 16a, 16b if desired.

In the embodiment shown, networked distributed motion control system 10 includes PC which is operated with a non-real-time operating system. However, it is to be understood that networked motion control system 10 can be alternately configured with a PC running a real-time operating system. The latency of a real-time operating system is relatively small and predictable compared to a non-real-time operating system. In a networked distributed motion control system in accordance with the present invention and configured with a real-time operating system, the buffering of data packets to the drive cards is performed in the manner described herein (i.e., dependent at least in part upon the maximum latency period). Thus, the amount of data which is buffered to the drive cards may be reduced in accordance with the shorter latency period of a real-time operating system.

While this invention has been described as having a preferred design, the present invention can be further modified within the spirit and scope of this disclosure. This application is therefore intended to cover any variations, uses, or adaptations of the present invention using the general principles disclosed herein. Further, this application is intended to cover such departures from the present disclosure as come within the known or customary practice in the art to which this invention pertains and which fall within the limits of the appended claims.

What is claimed:

1. A method of communicating within a motion control system, said method comprising the steps of:
programming a plurality of drive cards to perform predetermined mathematical and logical functions in response to high-level commands;
configuring each of said plurality of drive cards with a respective unique predetermined delay time;
distributing intelligence throughout said motion control system by electrically interconnecting each of said plurality of drive cards with a local area network, each of said plurality of drive cards being further electrically connected to a corresponding component of said motion control system;
transmitting to said plurality of drive cards said high-level commands across said local area network;
delaying response to said high-level commands by each respective one of said plurality of drive cards according to said unique predetermined delay time;
responding to said high-level commands by each of said plurality of drive cards following the expiration of said unique predetermined delay time; and
temporarily suspending communication over said local area network following response by said plurality of drive cards to said high-level commands to thereby ensure deterministic communication over said local area network.

2. The method of communicating within a motion control system of claim 1, wherein said local area network comprises an Ethernet network.

3. The method of communicating within a motion control system of claim 1, wherein each said drive card includes a network controller, microprocessor, packet memory, memory, and firmware.

4. The method of communicating within a motion control system of claim 1, wherein each of said transmitting step and said responding step comprise the transmission of data packets across said local area network.

5. The method of communication within a motion control system of claim 4, wherein said transmitting step comprises a personal computer transmitting said data packets.

6. The method of communicating within a motion control system of claim 5, wherein said personal computer includes an operating system, said operating system being one of a non-real-time operating system and a real-time operating system.

7. The method of communicating within a motion control system of claim 6, wherein said personal computer includes motion control software running under said operating system.

8. The method of communicating within a motion control system of claim 4, comprising the further step of selectively storing within each of said plurality of drive cards said transmitted data packets.

9. The method of communicating within a motion control system of claim 8, comprising the further step of monitoring with said personal computer the level of transmitted data packets stored within each of said plurality of drive cards.

10. The method of communicating within a motion control system of claim 9, comprising the further steps of:
establishing upper and lower trigger points for the level of transmitted data packets stored within each of said plurality of drive cards;
comparing the level of transmitted data packets stored within each of said plurality of drive cards with said upper and lower trigger points; and
adjusting the rate at which data packets are transmitted to each of said plurality of drive cards dependent at least in part upon said comparing step.

11. The method of communicating within a motion control system of claim 1, comprising the further step of establishing promiscuous peer-to-peer communication within said local area network whereby the responses of each respective one of said plurality of drive cards to a high-level command is received by each of the others of said plurality of drive cards.

12. The method of communicating within a motion control system of claim 11, comprising the further steps of:
storing within each respective one of said plurality of drive cards the responses to said high-level commands from each of the others of said plurality of drive cards;
determining the relevance of each of the responses stored within each of said plurality of drive cards; and
discarding non-relevant responses stored within each of said plurality of drive cards.

13. A networked distributed motion control system, comprising:
a local area network;
a personal computer electrically interconnected to said local area network;
at least one drive card interconnected to said local area network; and
at least one motor, each of said at least one motor interconnected with a corresponding one of said at least one drive card.

14. The network distributed motion control system of claim 13, wherein said local area network comprises an Ethernet network.

15. The networked distributed motion control system of claim 13, wherein each of said at least one drive card includes a respective network controller, microprocessor, packet memory, memory, and firmware.

16. The networked distributed motion control system of claim 13, further comprising at least one input/output device interconnected to a corresponding one of said at least one drive card.

17. The networked distributed motion control system of claim 13, further comprising operating system software, said operating systems software being one of a non-real-time operating system and a real-time operating system, said personal computer running said operating systems software.

18. The networked distributed motion control system of claim 17, wherein said non-real-time operating system software comprises a version of WIDOWS operating system.

19. The networked distributed motion control system of claim 13, further comprising a motor and drive subassembly, said motor and drive assembly including a housing, blocks of insulative material being mounted to said housing, a respective one of said at least one motor and a corresponding one of said at least one drive card are mounted within said housing, said drive being mounted to said blocks of insulative material.

20. The networked distributed motion control system of claim 13, wherein said housing includes a power connector and a network connector.
